(19) United States
(12) Patent Application Publication
(10) Pub. No.: US 2009/0314829 A1
(43) Pub. Date: Dec. 24, 2009

(54) Systems, Methods, and Devices for Replication of Data onto Wireless Sensors

(76) Inventor: Clarke McAllistor, Eugene, OR (US)

Correspondence Address: PETER A. HAAS, ESQUIRE, 1929 SW 13TH AVENUE, PORTLAND, OR, 97201, US

(21) Appl. No.: 12/124,768

(22) Filed: May 21, 2008

Related U.S. Application Data
(60) Provisional application No. 60/939,603, filed on May 22, 2007.

(51) Int. Cl. G06F 17/00

(52) U.S. Cl. 235/375; 235/439; 235/462.01

(57) ABSTRACT

In one embodiment the present invention comprises a bar code scanner and an encoder for commissioning RFID transponders and includes a housing encasing a motor assembly, an RFID interrogator, a wireless communication means for transferring instructions and data from and to a remote host, on-board memory, a processor, and an antenna with corresponding mechanism to encode and verify a programmable RFID transponder on a conveyance web. The present invention further includes novel methods for commissioning RFID transponders, as well as methods for recycling and reusing the protective enclosure.

### PRIORITY CLAIM

This present application claims benefit under 35 U.S.C. Section 119(e) of U.S. Provisional Patent Application Ser. No. 60/939,603, filed on 22 May 2007, the disclosure of which is expressly incorporated by reference for all purposes. Background

### BACKGROUND

The present invention relates to a system, including methods and devices, utilizing wireless sensor devices and RFID (radio-frequency identification) transponders. Specifically, the present invention relates to a system incorporating novel devices and methods that enable point-of-use and on-demand commissioning of RFID transponder-equipped wireless sensors.

Radio-frequency identification (RFID) transponders enable improved identification and tracking of objects by encoding data electronically in a compact transponder or label. And, advantageously, the compact transponder or label does not need external, optically recognizable or human-readable markings. In fact, using the Gen2 EPC specification, a three-meter read-distance for RFID transponders is common—even on high-speed material handling lines.

Radio-frequency identification (RFID) transponders, typically thin transceivers that include an integrated circuit chip having radio frequency circuits, control logic, memory and an antenna structure mounted on a supporting substrate, enable vast amounts of information to be encoded and stored and have unique identification. Commissioning, the process of encoding specific information (for example, data representing an object identifier, the date-code, batch, customer name, origin, destination, quantity, and items) associated with an object (for example, a shipping container), associates a specific object with a unique RFID transponder. The commissioned transponder responds to coded RF signals and, therefore, readily can be interrogated by external devices to reveal the data associated with the transponder.

Current classes of RFID transponders rank into two primary categories: active RFID transponders and passive RFID transponders. Active RFID transponders include an integrated power source capable of self-generating signals, which may be used by other, remote reading devices to interpret the data associated with the transponder. Active transponders include batteries and, historically, are considered considerably more expensive than passive RFID transponders. Passive RFID transponders backscatter incident RF energy to specially designed remote devices such as interrogators.

Combining the benefits of the latest technology in RFID transponders with sensing devices, a broader class of devices called wireless sensors is emerging. Wireless sensors have a unique identity, sense one or more attributes within its environment, and report its identity and data corresponding to the sensed attributes. For example, a wireless sensor interprets environmental conditions such as temperature, moisture, sunlight, seismic activity, biological, chemical or nuclear materials, specific molecules, shock, vibration, location, or other environmental parameters. Wireless sensors are distributed nodes of computing networks that are interconnected by wired and wireless interfaces.

Wireless sensors, made using silicon circuits, polymer circuits, optical modulation indicia, an encoded quartz crystal diode, or Surface Acoustic Wave (SAW) materials to affect radio frequency or other signaling methods, communicate wirelessly to other devices. For example, certain embodiments of wireless sensors communicate on a peer-to-peer basis to an interrogator or a mobile computer. Communication methods include narrow band, wide band, ultra wide band, or other means of radio or signal propagation methods.

Additional examples of RFID transponders, wireless tags, and wireless sensors are more fully discussed this inventor's co-pending U.S. Patent Application Publication No. 2006/0080819, entitled “Systems and Methods for Deployment and Recycling of RFID Tags, Wireless Sensors, and the Containers Attached thereto,” published on 20 Apr. 2006, which is incorporated by reference for all purposes in this document.

One problem of prior-art systems, such as conventional print labels or barcode systems, includes a requirement for line of sight and an overdependence on the optical quality of the label. Many factors can render such a label unreadable including printing errors, excess ink, insufficient ink, physical destruction of the markings, obstruction of the markings due to foreign matter, and, in extreme cases, outright deception by placing an altered label over the top of such a print label.

RFID transponder labeling eliminates the need for an optically readable print label and overcomes all of the shortcomings related to print quality and the need for line of sight to scan the label. Moreover, RFID transponder labels enable secure data encryption, making outright deception considerably less likely to occur. However, current RFID label systems have their own limitations as well.

One problem of prior-art systems is the total cost for encoding and applying wireless sensors. In the case of manual encoding and application of RFID transponders or wireless sensors, the cost is dominated by labor costs. Therefore business process integration plays a significant role in reducing the total cost of ownership of tagging objects. For example, in many supply chain applications, case picking is performed during the fulfillment of a customer order, this is an operation where individual cases or groups of cases are manually handled. Similarly in receiving of goods at retail, manufacturing, or distribution receiving docks are other business process where individual cases are manually handled. In either of these types of business processes where individual cartons are handled, there is an opportunity to encode and apply an RFID tag or wireless sensor to each carton on a selective basis.

Generating a unique serial number is imperative, and is required for EPCglobal RFID tagging implementations. Serialization requires a central issuing authority of numbers for manufacturers, products, and items to guarantee uniqueness and to avoid duplication of numbers. Blocks of numbers are distributed to remote locations globally. Unless a product (or SKU) is serialized at one location, the numbering space is usually partitioned according to some method, or each remote location receives each number one-by-one. Either way, there is eventually a reconciliation of serial number usage with a granularity of either one or several numbers at a time.

A preferred method of generating unique serial numbers is to assign unique numbers in a central location, such as in a label converter facility where unique bar coded labels are printed. Each unique label is then packed and shipped to remote locations, usually either in sheets or rolls. Upon arrival at a manufacturing facility, rolls are loaded onto high speed label applicators that apply one serialized label onto each carton. As those serialized cartons move through the supply chain, they may eventually arrive at a case pick location, a receiving dock, or similar location where a serialized carton is selected for having an RFID transponder applied to it. Using a bar code scanner to read one or more bar codes sufficient information can be collected to uniquely encode that data into an RFID transponder and apply it to that carton.

The uniqueness of an identifier is critical to the success of almost any tracking system. Assuring uniqueness is not necessarily simple. A generically descriptive bar code can be matched to authorizations for selected numbering systems that provide additional data fields including a unique serial number or using algorithms that assure uniqueness through numerical representations of time and space.

Authorizations for one or more classes of objects are preferably loaded into encoder 15, 30, or 60, where such authorizations include data fields such as manufacturer ID, item reference, manufacturer code lengths, filter values (that designate packaging levels such as item, case, pallet, etc.), serial number starting point for a block, and other pre-determined parameters. Such information is preferably loaded into the memory of the encoder in advance of tag commissioning operations. Thus if loaded with information for more than one object class, encoder 15, 30, or 60 does not have sufficient information to proceed with encoding a transponder until a single object class is selected for the present RFID transponder to receive; an ambiguity therefore exists that is preferably resolved with information entered by an operator using either a keypad or a bar code scanner. Reading printed indicia such as a bar code is a preferred method to resolve the ambiguity as to which object class the next RFID transponder is to receive a number from. Bar codes are used to eliminate errors and ambiguities that enable encoder 15, 30, or 60 to locally generate or replicate data for encoding into a data carrier such as an RFID transponder.

This type of data production and/or replication process is very fast and efficient. There is no absolute need to query a database in real time; hence there is no need for continuous wireless network connectivity. This simplification eliminates the possibilities for non-deterministic network delays. Non-deterministic delays are delays that cannot be guaranteed, usually due to the probabilistic nature of packet collisions that are common in Ethernet and WiFi. By eliminating the need to access a network database, the variable non-deterministic delays caused by changing database sizes, changing record counts, and database user load fluctuations are completely circumvented. Reduction or outright elimination of non-deterministic delays helps manual labor operate at maximum efficiency, allowing them to achieve a regular and dependable cadence in their transponder application processes.

Certain prior art systems use printer encoders to merge the printing and RFID transponder encoding operations into a single atomic transaction. This method is more expensive in every respect. It requires mobile distributed printing with nearly perfect networking implementations in order to achieve a smooth, easy, and regular manual transponder application process. This all comes at a higher price, size, and weight. Prior art implementations tend not to be mobile, as represented by U.S. Pat. No. 7,066,667 issued to Chapman et al. on 27 Jun. 2006 and include U.S. Pat. No. 5,899,476 issued to Barrus et al. on 31 May 2005, or by U.S. Pat. No. 6,246,326 issued to Wiklof et al. on 12 Jun. 2001, describe a device that commissions an RFID transponder with a printed label. This approach, however, introduces unnecessary waste, cost, and propensities for error. There is a growing category of applications that do not require anything other than a custom-encoded RFID transponder. This prior art calls for the inclusion of label printer hardware and related consumable materials that are not necessary for many RFID applications. Unneeded printer mechanisms create unnecessary complexities, size, and weight. In some instances this additional bulk hinders practical mobile applications. The result is that tagging solutions that include printing result in a higher total cost of ownership than a pure RF tag encoding system.

United States Patent Application No. 2003/0227528 by Hohberger et al. published on 11 Dec. 2003 describes another attempt at improving demand-print labels by providing a device that combines two standard, die-cut rolls of media, one of which may be a roll of RFID transponders, and the second, print-label stock, in an attempt to provide on-demand smart labels. As with the aforementioned references, this approach adds unnecessary cost and complexity by combining RFID transponders with demand-printed labels.

U.S. Pat. No. 5,382,784 by Noel H. Eberhardt issued on Jan. 17, 1995 describes a hand-held dual technology identification tag reading head with a gun-shaped housing and a trigger switch with two different ON positions. This patent discloses a hand-held device with a light transmissive window at one end, through which bar code scanning light passes and around which an RFID reading antenna is positioned. Eberhardt discloses embodiments for reading either bar code or RFID information from a label using a hand-held, dual-position trigger actuated device. This patent fails to offer any methods or devices for reading bar code information and using that information to encode an RFID transponder. In particular this patent fails to disclose any methods for conveyance of RFID transponders as part of a well-controlled transponder encoding process.

U.S. Pat. No. 6,486,780 by Sharon R. Garber et al issued on Nov. 26, 2002 discloses a hand-held item location device using RFID to seek and find library books. The disclosure emphasizes the importance of read range over great distances and large populations of RFID transponders, a quality that runs counter to the present invention that teaches how to localize radio frequency fields for programming only selected RFID transponders presented in succession for well-controlled encoding. Garber teaches techniques for searching and reading large collections of transponders in a library, not semi-automated transponder commissioning processes. The physics of Garber's invention is poorly suited to programming anything other than one transponder at a time that is carefully isolated by great distances from any other RFID transponder to avoid programming information into the wrong transponder.

U.S. Pat. No. 5,280,159 by Darald R. Schulz et al. issued on Jan. 18, 1994 discloses a pistol-grip RFID reader with a separate hand-held data terminal which together are used to read RFID transponders. Again this invention, like other prior art fails to teach a viable method or apparatus for reliable commissioning large volumes of RFID transponders.

Douglas Walter Main and Tim A. Kassens disclose, in U.S. Pat. No. 5,763,867 issued on Jun. 9, 1998, a hand-held data terminal with various scanner modules for the purpose of data acquisition. This patent, along with there subsequent and related disclosure in U.S. Pat. No. 5,962,837 issued on Oct. 5, 1999, are examples of hand-held data collection devices for sweeping an RFID interrogation beam about an broad area around an operator (for example, a storage room or bulk-shelf location in a warehouse). This operating distance, however, lies beyond a close-range distance of a couple of inches and is limited to interrogation and data-acquisition, not encoding. Further, such devices are unable to limit their communication to RFID transponders that are in close-proximity of a few inches of the operator holding a hand-held encoder that includes a near field coupler.

Curt L. Carrender, Jeremy A. Landt, and Donald F. Speirs disclose in their Dec. 15, 1998 U.S. Pat. No. 5,850,187 another RFID reader that is designed “to allow for identification of objects at locations removed from the remote host unit”. This, along with their Jun. 20, 2000 U.S. Pat. No. 6,078,251, “retrieve object identification data from a selected object.” However, these disclosures fail to address controlling the inherently propagative nature of the electric fields of radio waves in order to restrict their range to within the width of a single transponder.

U.S. Pat. No. 6,195,053 issued to Kodukula and Ackley on 27 Feb. 2001 discloses an antenna consisting of a U-shaped conductive bracket, supports an optical reader and communicates with RFID transponders. However, this disclosure does not address the need for shielding and near-field coupler design to optimize the inherent long-range characteristics of the RFID transponder.

Helton and Wiklof's Mar. 19, 2002 U.S. Pat. No. 6,357,662 discloses a device that a user can selectively control a bar code scanner and an RFID reader to acquire information about an asset. However, this disclosure does not address creating and encoding a unique identifier for attachment to and subsequent identification of the asset.

Zebra Technologies Corporation's Principal Engineer Boris Y. Tsirline is the principal inventor of U.S. Pat. No. 6,848,616 (issued on 1 Feb. 2005 to Tsirline et al.) with the title “System and method for selective communication with RFID transponders”. In that patent the inventors describe a system having an RFID transceiver that is adapted to communicate exclusively with a single RFID transponder. They disclose that the system includes a printhead and a magnetic flux generator having a planar coil formed as a trace upon a first layer of a printed circuit board. As with the aforementioned references, this approach adds unnecessary cost and complexity by combining RFID transponders with demand-printed labels, and uses a near field coupler design that does not concentrate the magnetic flux as selectively as the present invention disclosed herein.

U.S. Pat. No. 7,223,030 by Fessler et al (issued on 29 May 2007) and U.S. Pat. Nos. 7,249,819 (issued on 31 Jul. 2007) and 7,187,294 (issued on 6 Mar. 2007) both by Burdette et al, (lead inventors of Lexmark International, Inc.) disclose a printer/encoder system, and attempt to overcome the problems of detecting and locating an RFID inlay that is embedded somewhere in a printed label stock. The present invention overcomes that problem by eliminating the (larger) label, and only encoding RFID transponders, which generally have a physical outer dimension that very closely matches the embedded RFID transponder inlay dimensions.

United States Published Patent Application No. 2007/0150219, published on 28 Jun. 2007 by Cawker et al. of Weyerhaeuser Company, discloses a method of applying and verifying RFID transponders using a conveyor for moving objects along a predetermined path. Their invention makes use of cameras to identify the proper position for a label. The present invention overcomes the size and cost requirements of a system comprised of a conveyor and cameras by using human operators for motion and simple reflective beam sensors for spatial positioning and label placement.

So, despite recent advances in RFID technology, the state-of-the-art does not fully address the needs of simple, FAST, efficient, economical, smooth, reliable commissioning of RFID transponders and wireless sensors. large-scale adoption and deployment of RFID transponders depends on thousands of distributed locations that implement simple and efficient manual transponder commissioning processes. Such systems should further include means and processes for efficient commissioning of batches of RFID transponders, without the need for realtime wireless connectivity to an infrastructure database on a transponder-by-transponder basis.

### SUMMARY OF THE INVENTION

The present invention overcomes the shortcomings of the prior-art attempts and, accordingly, provides systems, methods, and devices that commission RFID transponders on-demand and at a point-of-use in a compact solution that is well-suited to mobile use in multiple applications. The present invention is used for reading data from or encoding data onto wireless transponder data carriers with no external authorizations or queries required on a transponder-by-transponder basis. Additionally this invention teaches a preferred method and apparatus for commissioning RFID transponders without requiring continuous use of a screen or keypad to control operations. Further advantages of the present invention will be well-appreciated by those skilled in the art upon reading this disclosure including the appended figures of the drawing.

In one preferred embodiment, the present invention includes a method for commissioning RFID transponders comprising: Providing a roll or sheet of RFID transponders; providing a cartridge or other pre-packaged self-contained supply of RFID transponders; providing an encoder; inserting the roll or sheet in the cartridge or other pre-packaged self-contained supply of RFID transponders; coupling the cartridge to the encoder; acquiring information to encode from printed indicia; encoding the information on at least one RFID transponder; and adapting the process of attachment of the encoded transponder to the target surface along a vector that is nearly parallel to the target surface based upon real time feedback from the surrounding environment.

### DRAWINGS

FIG. 1 is a block diagram of the system and environment according to one embodiment of the present invention.

FIG. 2 is a top view of a possible RFID transponder according to one embodiment of the present invention.

FIG. 3 is a material stack specification of an RFID transponder according to one embodiment of the present invention.

FIG. 4 is a side view of a web of release liner containing RFID transponders, provided on a source roll, stretched tight around a peel device, and advanced forward onto a take-up reel according to one embodiment of the present invention.

FIG. 5 is an orthogonal view of a mobile RFID encoder according to one embodiment of the present invention.

FIG. 6 is a side view of a handheld mobile encoder with an integrated bar code scanner according to one embodiment of the present invention.

FIG. 7 is a diagram of a wearable wireless bar code scanner according to one embodiment of the present invention.

FIG. 8 is a flow chart of a first method according to the present invention.

### DESCRIPTION OF THE INVENTION

Making reference to various figures of the drawing, possible embodiments of the present invention are described and those skilled in the art will understand that alternative configurations and combinations of components may be substituted without subtracting from the invention. Also, in some figures certain components are omitted to more clearly illustrate the invention. In some figures similar features share common reference numbers.

To clarify certain aspects of the present invention, certain embodiments are described in a possible environment—as identification means for containers. In these instances, certain methods make reference to containers such as loaded pallets, paperboard boxes, corrugated cartons, pharmaceutical containers, and conveyable cases, but other containers may be used by these methods. Certain embodiments of the present invention are directed for use with steel drums, commercial corrugated shipping cartons, tagged pallet-loads of shrink-wrapped cases, consumer-goods packaging, consumer goods, automobile windshields, industrial components, or other methods of identifying objects using RFID transponders or wireless sensors, or both. In certain embodiments the target surface to which a transponder will be attached is a container. In some applications the target surface is moving while the encoder device is stationary. Furthermore the moving target surface may be objects on a conveyor. In yet other embodiments the target surface may be a web of release liner from which encoded transponders will be later removed and applied to an object for identification.

Some terms are used interchangeably as a convenience and, accordingly, are not intended as a limitation. For example, transponders are used interchangeably with the term tags and the term inlay is used interchangeably with inlet. This document generally uses the term tag or RF Tag to refer to passive transponders, which do not include a battery, but include an antenna structure coupled to an RFID chip to form an inlay which is thin and flat and may be constructed on top of a layer of foam standoff, a dielectric material, or a folded substrate structure. Passive transponders typically include a pressure-sensitive adhesive backing. However, certain aspects of the present invention work equally well with active transponders. A third type: a battery-assist tag is a hybrid RFID transponder that uses a battery to power the RFID chip and a backscatter return link to the interrogator. Programmable transponders enable data to be read, written or stored more than once.

Suitable environments or applications for certain aspects of the present invention include shipside receiving of automobiles, case picking operations that include selective tagging process steps, receiving untagged cartons into an RFID-enabled retail store or a manufacturing plant.

The systems, methods, and devices of the present invention utilize an RFID transponder or wireless sensors as a component. Certain RFID transponders and wireless sensors operate at Low Frequencies (LF), High Frequencies (HF), Ultra High Frequencies (UHF), and microwave frequencies. HF is the band of the electromagnetic spectrum that is centered around 13.56 MHz. UHF for RFID applications spans globally from about 860 MHz to 960 MHz. Transponders and tags responsive to these frequency bands generally have some form of antenna. For LF or HF there is typically an inductive loop. For UHF there is often an inductive element and one or more dipoles or a microstrip patch or other microstrip elements in their antenna structure. Such RFID transponders and wireless sensors utilize any range of possible modulation schemes including amplitude modulation, amplitude shift keying (ASK), double-sideband ASK, phase-shift keying, phase-reversal ASK, frequency-shift keying (FSK), phase jitter modulation, time-division multiplexing (TDM), or Ultra Wide Band (UWB) method of transmitting radio pulses across a very wide spectrum of frequencies spanning several gigahertz of bandwidth. Modulation techniques may also include the use of Orthogonal Frequency Division Multiplexing (OFDM) to derive superior data encoding and data recovery from low power radio signals. OFDM and UWB provide a robust radio link in RF noisy or multi-path environments and improved performance through and around RF absorbing or reflecting materials compared to narrowband, spread spectrum, or frequency-hopping radio systems. Wireless sensors are reused according to certain methods disclosed herein. UWB wireless sensors may be combined with narrowband, spread spectrum, or frequency-hopping inlays or wireless sensors.

A. System and Encoder Overview

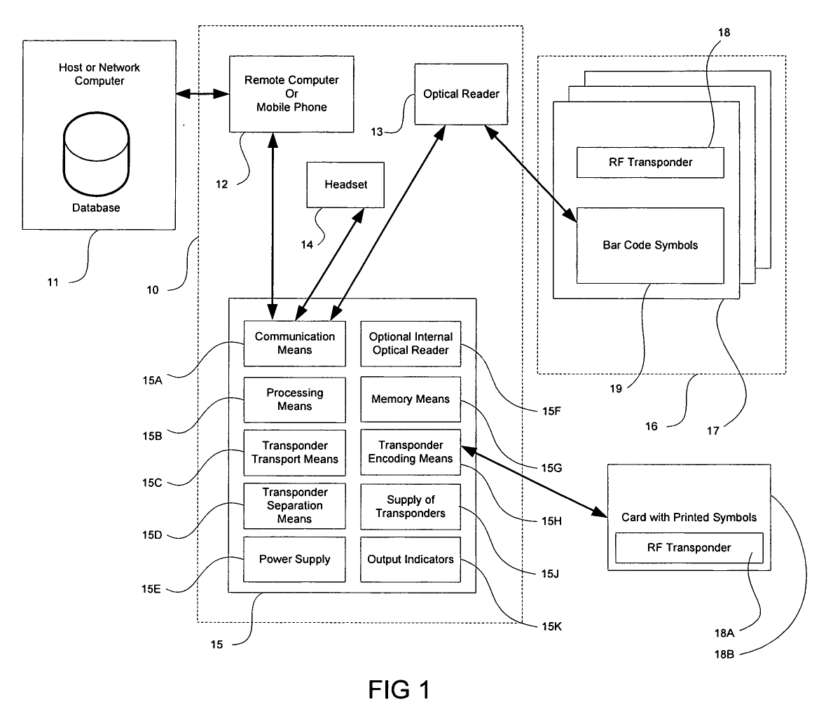

FIG. 1 shows one system 10 according to the present invention in a typical environment, such as a packaging or distribution facility wherein a collection 16 of entities 17 with visual external labels 19 exist and a sub-set (or all entities) need to be associated with a wireless RFID transponder, tag, or label 18. The object 17 needing an RFID transponder 18 could be a packing container. As entities 17 are pulled from the collection 16, an optical reader 13 or 15F reads and decodes the machine readable symbols printed on visual external label 19.

The present invention includes a system for commissioning wireless sensors at a point of use and on-demand. For example, in one embodiment, the present invention incorporates a mobile encoder device 15, 30, or 60 which may be held in the hand of an operator. Mobile encoder device 15, 30, or 60 is preferably powered by rechargeable batteries or a fuel cell.

System 10 includes at least four possible intermittently connected entities if they are present and connected: mobile encoder 15, remote computer or mobile phone 12, optical reader 13, and headset 14. A preferred short range wireless connection means 15A such as a WLAN (Wireless Local Area Network) or PAN (Personal Area Network) may be established from time to time between mobile encoder 15 and remote computer or mobile phone 12, optical reader 13, and/or headset 14. There is a preference for low power wireless connection apparatus within mobile encoder 15 so as to realize the greatest possible battery life in light weight mobile encoder 15. Mobile encoder 15, 30, or 60 is in intermittent wireless communication with a mobile phone or computer 12 typically at close range through wireless communication means 15A. Database and associated host computer 11 may be housed at a remotely located facility that may optionally be accessed over a large distance through remote computer or mobile phone 12. A mobile phone is a preferred bridge between two or more wireless networks, for example a PAN and a wireless subscriber network that supports wireless data services for ultra mobile and remote tagging applications. Continuous wireless connection to a host database is not required for ongoing tag commissioning process steps disclosed herein.

A preferred embodiment for quasi-autonomous transponder encoding authority is realized when large pre-authorized blocks of serial numbers are made available to encoder 15 or 50 to utilize on object classes as objects of a class are presented for tagging. A preferred method of providing large blocks of pre-authorized blocks of object class serial numbers is to subdivide the entire object class serial number space into sectors that are defined by a limited number of MSB's (Most Significant Bits) of the serial number field. In a preferred embodiment serial number block sizes are sufficient to operate encoder 15 or 50 for extended periods of time without any further external authorization steps. For example autonomous operation for a week or more is possible with sufficiently large block sizes. Block allocations are preferably assigned with reference to how many encoders 15 or 50 are authorized to operate within the facilities of the owner of certain object class numbers.

GS 1 is a leading global organization dedicated to the design and implementation of global standards and solutions to improve the efficiency & visibility of supply and demand chains. GS1 defines epcGlobal SGTIN number fields as having a company prefix, an item reference, a partition value, and a filter value that comprise the object class information. A unique serial number is then added to that information to create each unique instance within each object class.

In a preferred embodiment, a block is allocated and managed using three numbers: a starting number that is the first serialized instance of a block, a block size which represents the total number of instances in the block, and a counter or index that represents how much of the block has been used during an encoding process. Using these three numbers and an optional lock bit, a simple database of object class authorizations can be built.

A preferred embodiment utilizes RFID authorization transponder 18A and a printed substrate 18B to physically handle object class serial number issuance authorizations. Authorization transponder 18A is interrogated by transponder reading/encoding means 15H. Preferred embodiments use the 96-bit EPC memory bank for specifying the block starting number, including the company prefix, item reference, partition value, filter value, and base serial number. The User Memory bank is used to hold and transfer the block size (preferably 16-bits), counter or index value (preferably 16-bits), a 16-bit header to identify the transponder as a valid member of a class of authorization transponder, a lock bit, and a CRC value to detect errors in all of the data fields. For example a CRC error would detect errors in storage, transponder selection, or data transmission. In preferred embodiments reading of data blocks from more than one RFID transponder would be avoided by selecting a transponder, checking that it is the correct type, contains valid authorization data, contains a valid header that signifies that it is an RFID authorization transponder 18A, and that all data read correctly verifies with a dedicated error detection field such as a CRC.

RFID authorization transponder 18A is preferably adhered to printed substrate 18B so that an operator can visually identify what object class or SKU is managed by the affixed authorization transponder 18A. A picture, icon, bar code, or human readable symbols are all useful for identifying the object class. An operator presses a button or scans a barcode that prompts encoder 15 to read and store the tagging authorization held by authorization transponder 18A. Once read, authorization transponder 18A is preferably electronically marked as ‘consumed’ or ‘locked’ by transponder encoding means 15H. EPC transponder ID fields that identify a specific type of chip are preferred for selecting the proper transponder, even when other RFID transponders are within range of the antenna or near field coupler of transponder encoding means 15H.

A collection of authorization transponders 18A comprises a database that can be physically transported without the need for a wireless communications link to encoder 15. Once read, database records are preferably stored in internal memory means 15G. In a preferred embodiment 12 to 14 bytes of Flash memory is used for each record to allocate 250 to 65536 instances of an object class, whereby the first byte of an EPC number is a fixed header value can be replaced in Flash memory by 8 bits of the allowable block size. One or two bytes in RAM are used to count or index through the block allocation as it is used. Thousands of data records of this type can easily fit into the memory space of an economical 8-bit microcontroller. In a preferred embodiment, where the GS1 SGTIN-96 header is replaced in memory with an 8-bit block size authorization, 2000 records for authorizing up to 255 instances per record, can be used to safely manage at least 500,000 tagging records using 24,000 bytes of Flash and 2000 bytes of RAM. Other embodiments using more bits to authorize and control larger blocks of numbers is possible at a slightly larger expense of memory.

Preferred embodiments of encoder 15, 30, or 60 will encode all of the GS1 identity types. Such types include the General Identifier (GID-96), Serialized Global Trade Identification Number (SGTIN), Serial Shipping Container Code (SSCC), Serialized Global Location Number (SGLN), Global Returnable Asset Identifier (GRAI), and the Global Individual Asset Identifier (GIAI). Other preferred embodiments are used to encode numbers that are a part of other numbering systems.

Data records are preferably loaded and stored through commands that are transmitted over wireless communication means 15A. In preferred embodiments, batch mode commands can be used in any of three ways: (1) to immediately affect the current operation by starting a batch tagging process for a specified SKU or object class; (2) to store authorizations in memory means 15G; and (3) to store authorizations in stored-value RFID transponder 18A.

When external connection is necessary, wired or wireless communication with an external host or numbering authority is established. Wireless communication means 15A is preferably a Wi-Fi or Bluetooth connection. A wireless node of a Bluetooth personal area network is used according one embodiment of the present invention. Model 100-SER manufactured by EmbeddedBlue of Poway, Calif. and the BISMS02 from EZURiO Ltd., a subsidiary of Laird Technologies, Inc. of Chesterfield, Mo. are examples of preferred OEM Serial Bluetooth modules. Other wireless interfaces may alternatively be used to achieve Serial Port Profile and other types of connectivity between encoder 15 and remote computer or mobile phone 12 and/or optical reader 13.

Other preferred embodiments of mobile encoder 15 and system 10 replace wireless communication means 15A with a cable, resulting in an embodiment of mobile encoder 15 with a tethered bar code scanner. A key advantage of an alternative embodiment of system 10 that utilizes a wired connection to optical reader 13 instead of wireless communication means 15A is a very simple solution having virtual immunity to any surrounding RF interference that might raise the noise floor hindering wireless communications.

The operator can cause mobile encoder 15, 30, or 60 to commission a transponder by scanning certain printed bar code symbols received through optical reader 13 which is connected to encoder 15 through wireless communication means 15A. Or alternatively internal optical reader 15F is used to scan printed bar code symbols. In either case data from optical reader 13 or 15F is delivered to processing means 15B. Certain preferred embodiments of system 10 use optical scanners with self-contained symbol decoding capabilities to deliver decoded symbol information to processing means 15B. Certain other embodiments of system 10 relies on processing means 15B to conduct some or all decoding operations to derive information from scanned symbols.

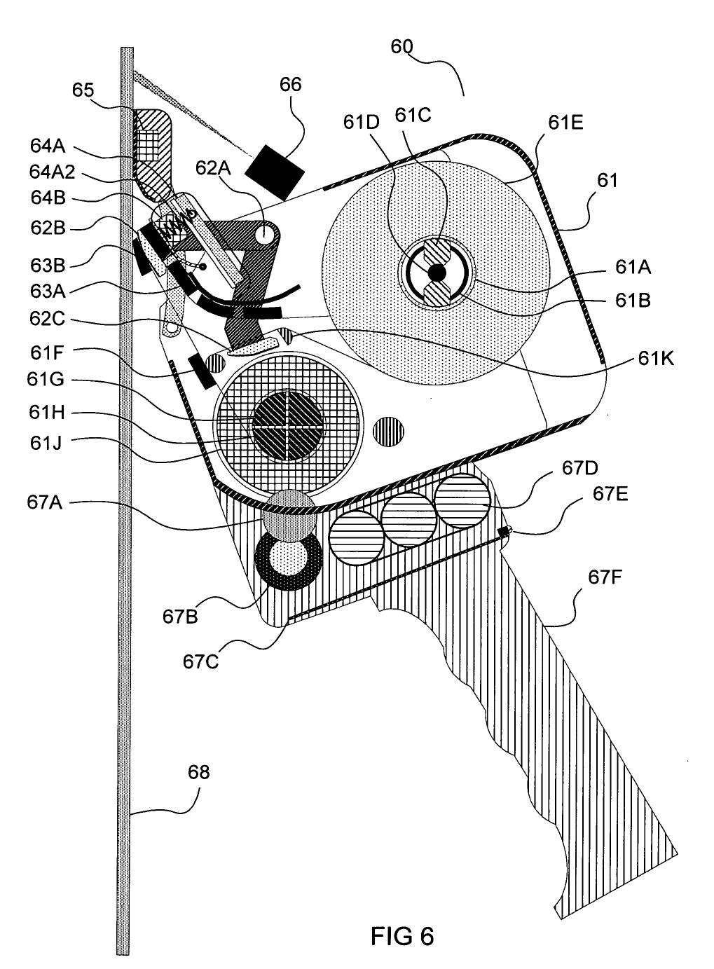

The information derived from the optical reader 13 or 15F is used by mobile encoder 15 to either directly or indirectly encode data into RF transponder 18 while it is still physically within mobile encoder 15. Mobile encoder 30 uses external optical reader 13, and alternatively mobile encoder 60 uses internal optical reader 15F, as embodied in reader 66 of FIG. 6. Preferred embodiments of optical reader 66 are mechanically aligned relative to transponder encoding means 15H or more specifically with the antenna or near field coupler of RFID interrogator 64A. Spatial alignment assures that an operator will be able to comfortably scan bar codes and then encode and apply RFID transponders along a line of movement such that the operator can easily assure proper placement of encoded transponders.

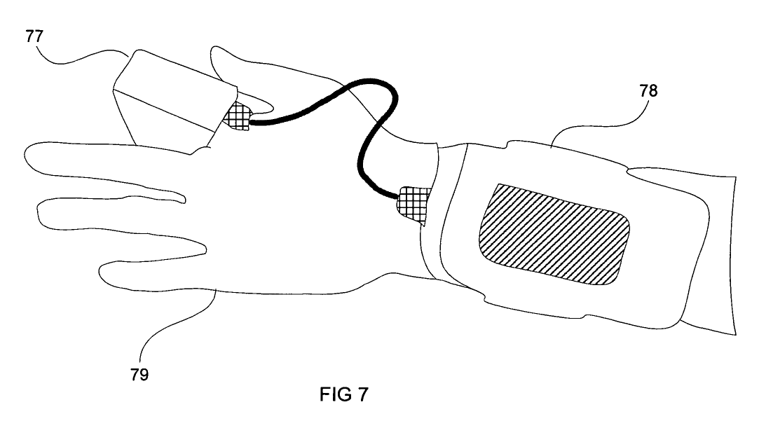

Symbol decoding functions may be physically, electrically, or logically separated from symbol scanning operations. One preferred embodiment of optical reader 13 is a model CHS-7M, CHS-7P, CRS-9M or CRS-9P Bluetooth ring scanner 77 shown in FIG. 7 all manufactured by Socket Communications of Newark, Calif. Ring scanner 77 if not completely self-contained with battery and wireless connection is, in a preferred embodiment tethered to a battery pack and wireless interface 78 strapped to the arm 79 of an operator. Certain preferred embodiments designate ring scanner 77 as the master node of a Bluetooth network. As a master, ring scanner 77 will preferably pair with a specific mobile encoder designated by a unique identifier that is also encoded onto a bar code affixed to the external housing of mobile encoder 15. Ring scanner 77 is used to scan that bar code and decode it to acquire the unique 12-hexadecimal digit Bluetooth address to perform a Bluetooth pairing operation that results in that instance of mobile encoder 15 becoming a slave on that network. Then whenever a bar code 19 is scanned, the Bluetooth-paired instance of mobile encoder 15 is notified of the new bar code data to support RFID transponder encoding operations or command inputs.

Processing scanned commands involves a processing step to determine that a bar code should be interpreted as a command or configuration instructions rather than as bar code 19 that identifies an object that is to be tagged. Commands are used to alter the flow and operation of mobile encoder 15.

FIG. 6 is a preferred embodiment of a mobile encoder wherein optical reader 66 is an OEM bar code scanner manufactured by such companies as Intermec or Motorola and is a preferred embodiment of optional internal optical reader 15F shown in FIG. 1.

In a preferred embodiment one or more bar codes are pre-printed and applied as symbol 19 on entity 17 in a manufacturing facility or other suitable location. Such bar codes are described in ISO/IEC draft document PDTR 24729-1 and are more generally referred to as one or more bar codes having Application Identifiers (AI) 01 and 21 encoded into them, and preferably include header information and other control bits that are required for certain protocols. AI 01 is used to represent the Stock Keeping Unit (SKU) as a GS1 Global Trade Identification Number (GTIN). AI 21 is used to serialize the SKU. Together the two AI's are used to specify a GS1 serialized GTIN (SGTIN). Bar codes can also be used to specify data payloads that use numbering systems other than the EPC numbering system. The Application Family Identifier (AFI) also plays an important role in designating alternative numbering authorities.

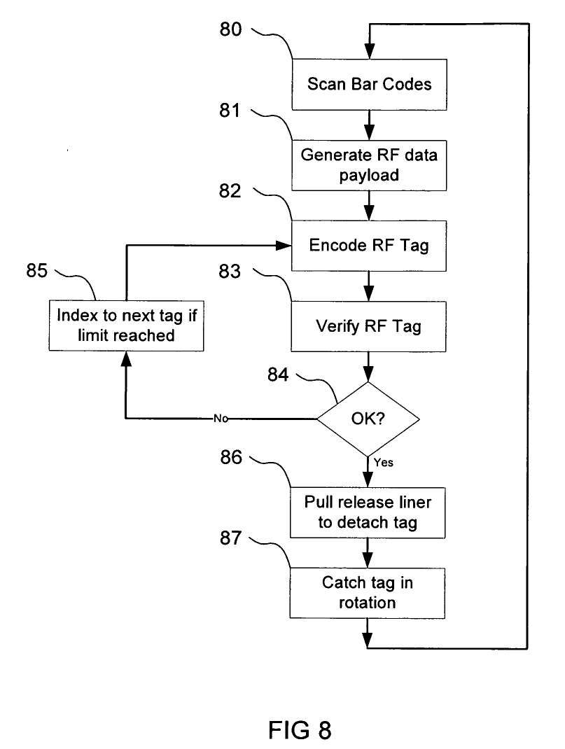

This preferred method that is described by the flow chart in FIG. 8 will allow batch mode operation where there are at best intermittent connections with remote computer 12. This preferred method allows existing label application and/or printing hardware located on existing manufacturing lines to provide in printed symbolic form all data that would be encoded into an RF transponder. By providing printed symbols, manufacturers do not have to incur either the cost of that transponder or the special equipment that is required to encode and apply RF transponders.

Optical reader 13 or 66 is described above and is used as the primary source of real time data input for the mobile encoding system that uses an embodiment such as mobile encoder 30 or 60. Optical reader 13 or 66 is also preferably used to scan special bar codes that instruct mobile encoder 15, 30, or 60 to perform certain prescribed functions which will be described below.

Certain preferred embodiments of system 10 include headset 14 which may be a headset worn by the operator or a Bluetooth-linked loud speaker that is mounted to a pallet jack or fork lift truck. Headset 14 is optionally used by system 10 to give instructions, confirmation signals, or warnings to the operator. Synthesized speech or audible tones are used to interact with the operator through headset 14.

In these aforementioned embodiments, the mobile encoder 15 is a portable device that can be easily mounted in a fixed location, carried such as mobile encoder 60, or worn by a human operator such as mobile encoder 30, or hung from a suspended retractable tool cable. As such, the mobile encoder 15 includes an internal power source 15E or 67D such as a rechargeable lithium-ion battery. Further details of possible configurations of the mobile encoder will be further detailed in subsequent sections of this disclosure.

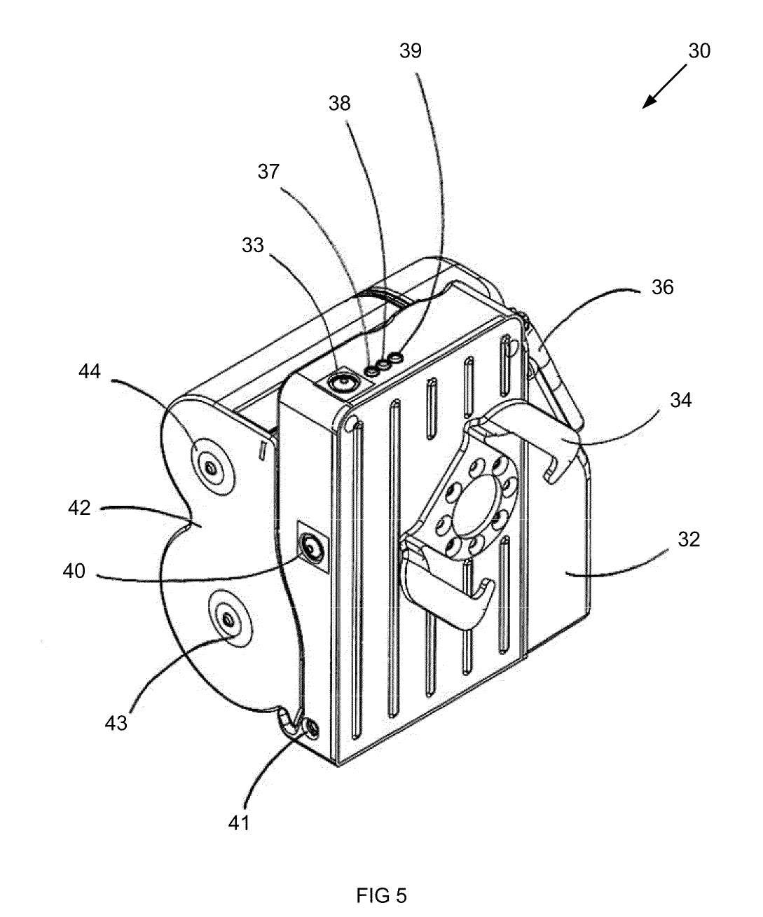

In the system 10 of FIG. 1, the mobile encoder 15 carries a supply of un-commissioned, blank, or securely encodable RFID transponders 15J, 25, 43, or 61E. Once the desired data is accumulated by mobile encoder 15 it advances the transponder commissioning process by encoding an RFID transponder using transponder transport means 15C and transponder encoding means 15H and any one of several preferred encoding algorithms to program an RFID transponder or label 18 for the object 17. Transponder separation means 15D is used to separate a properly encoded transponder 18 from release liner conveyance web 22 by breaking the bond at adhesive layer 21D on the leading edge of transponder 18. Transponder separation means 15D is preferably a peel device 23 as shown in FIG. 4 or peel device 62B in mobile encoder 60. Peel devices 23 or 62B are preferably made from anti-static plastic, metal, or other material that will conduct electrostatic charge away from transponder 18 and release liner 22. The commissioned transponder or label 18 is associated and applied to the target object by known means including a human operator or a machine transfer as will be further described in this disclosure.

B. RFID Transponders

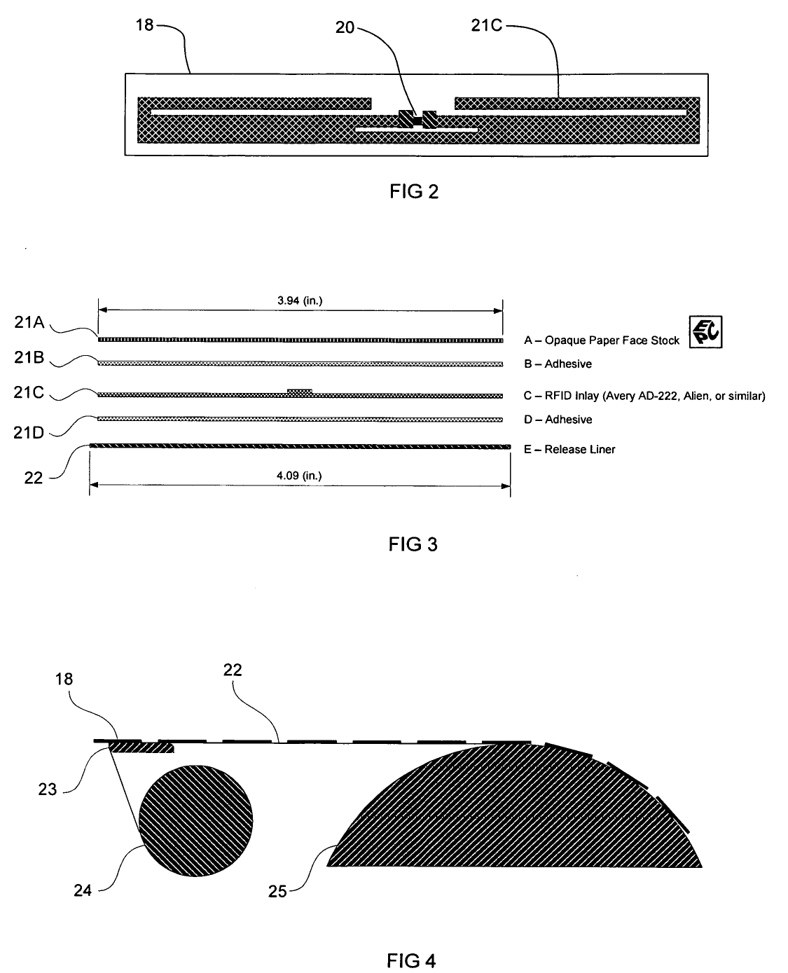

FIG. 2 shows a possible RFID transponder 18. RFID transponders, essentially, comprise an RFID integrated circuit (IC) device (or “chip”) 20 bonded to an antenna apparatus 21C, formed on a substrate that is often plastic such as Mylar (a registered trademark of E. I. Du Pont De Nemours and Company Corporation of Wilmington Del., polyester, or PET. One way to form an antenna structure is to etch copper from a substrate. An alternate way includes printing multiple layers of conductive ink onto a substrate. One additional method includes stamping UHF antennae from thin sheets of aluminum or by selective aluminum deposition onto a substrate. In certain embodiments, RFID transponders and wireless sensors are recovered from waste streams for reconditioning, reprogramming, and reuse.

Other suitable RFID transponders include designs that combine a dielectric spacer behind inlay antenna 21C to create a transponder that performs well over a broad range of packaging conditions or objects by separating the metallic antenna inlay 21C from surrounding metals that may detune it, or liquids that may absorb RF energy from it. The dielectric material is a foam standoff material or an expanding mechanical structure that provides lift from the target object and also a more robust structural integrity to additionally protect the transponder from mechanical damage.

In preferred embodiments, hundreds or thousands of instances of RFID transponder 18 are manufactured on a continuous web of flexible material with a spatial separation between them, preferably at regular intervals. Certain preferred embodiments use adhesive-backed transponders 18 adhered to release liner 22 as shown in FIG. 4, while other embodiments use the transponder material as its own conveyance that is severed from the rest of the web at predetermined locations, preferably after encoding and verifying transponder 18 is properly functioning.

In preferred embodiments of the present invention, the face stock material has a physical outline that is not much larger than the physical outline of the inlay itself. This is in contrast to labels which can have at least twice the surface area of the inlay or a direct-printed antenna structure in order to provide space for printed information. By having a label outline that is so much larger than the inlay surface area, there are a many possible combinations of inlay placement within the boundaries of a large printable label. This creates a problem and a challenge for printer/encoders that have to find and locate an inlay before attempting to encode it. By contract, the present invention uses the detectable optical characteristics of the tag's minimal physical outline to position the transponder for encoding. This transponder positioning method is superior and an improvement over prior art that uses printed label stock as a carrier for RFID inlays wherein the physical dimensions of printed labels are not in any way a reliable indication of the location of the RFID inlay within the label. This is another example of how demand label printing further complicates RFID transponder encoding.

In one embodiment that is an exception to the minimal outline transponder design and positioning method described above, is transponders that have a very long physical shape that can be used to create a loop to secure an encoded transponder to a tree, a bush, or the handle of a piece of luggage. Preferred embodiments of such transponders are folded or rolled in order to package them onto a dispensing roll or packaged into a magazine or cartridge in a fan fold pattern. The resulting bundle of back-and-forth ‘Z’ folded or fan folded face stock material results in a compact package that minimizes the amount of release liner that needs to be wasted for each tag. Each z-folded transponder is then easily encoded and dispensed from encoder 15, 30 or 60. Transponders that can be encoded, verified, dispensed, and unfolded are advantageously used in forestry, ornamental nurseries, and airline baggage tracking applications where manual tagging is required.

In another embodiment, transponder 18 is pushed out of encoder 15 instead of being pulled out through tensile extraction. A transport mechanism for pushing transponders utilizes a gripping method such as friction or teeth that penetrate the webbing. Although there is a risk of jamming or mutilating the webbing, the advantage is that there is no need for a release liner to pull the transponder supply through encoder 15 using tensile extraction. A preferred ‘tractor feed’ embodiment mitigates the risk of web mutilation by utilizing a regular pattern of precut holes along one or both edges of the webbing, into which cog members of a drive mechanism engage to advance the webbing. A tractor feed embodiment is part of Transponder Transport Means 15C of FIG. 1 whereby a motor and gear train delivers drive torque to the web through friction rollers, penetrating teeth, cogs, or other mechanical engagement means. In such an embodiment, the preferred transponder separation means is a web cutter that is used to separate encoded transponders from unencoded tags. A web cutter can be either active or passive, in other words cutting force can originate with a motorized mechanism or with an operator's handling during dispensing and transponder detachment. A row of plastic or metal saw teeth is a preferred embodiment of a passive transponder separation device.

In another preferred embodiment, transponder 18 is manufactured on a high speed press, a bar code is printed onto face stock of transponder 18 and information that is representative of that bar coded information is also encoded into microchip 20. Then encoder 30 or encoder 60 preferably read that information from RFID microchip 20 and associate it with a transponder commissioning process that may or may not include the programming of additional information into RFID microchip 20. This is a novel method of reading bar coded information on transponder 18 without using a bar code scanner to do so within encoder 30 or 60.

In one embodiment, additional transponder layers include a thin and flexible energy cell comprising two non-toxic, widely-available commodities: zinc and manganese dioxide. One suitable energy cell is developed by Power Paper Ltd. of 21 Yegia Kapayim Street, Kiryat Arye, Petah Tikva, P.O.B. 3353, ISRAEL 49130, and incorporates an innovative process that enables the printing of caseless, thin, flexible and environment-friendly energy cells on a polymer film substrate, by means of a simple mass-printing technology and proprietary inks. The cathode and anode layers are fabricated from proprietary ink-like materials that can be printed onto virtually any substrate, including specialty papers. The cathode and anode are produced as different mixes of ink, so that the combination of the two creates a 1.5-volt battery that is thin and flexible. Unlike conventional batteries, this type of power source does not require casing.

FIG. 3 illustrates how a top layer of an RFID transponder assembly comprises a paper face-stock 21A, which is a very low-cost material but also is the least environmentally resilient. UV-resistant plastic face-stock generally provide the best survivability in outdoor and rough-service environments, and also provide the best protection for the RFID transponder assembly.

A bottom layer of pressure-sensitive adhesive (PSA) 21D often is used for attachment of transponders to objects and often is referred to as a wet inlay or a wet tag or a wet transponder because of adhesion layer 21B. A web of release liner 22 is used to convey transponders 18 through the transponder encoding process.

FIG. 4 also shows how transponders 18 are rolled onto reels in preparation for encoding. Source roll 25 contains a supply of transponders ready for encoding. Release liner 22 conveys transponders 18 around peel device 23. Unless transponders 18 are mechanically prevented from rotating around peel device 23, they are conveyed onto take-up roll 24. Take-up reel 24 advances forward while source roll 25 lags behind due to drag created by a clutch, brake, motor or other back-torque generating device. Opposing torques of take-up reel 24 and source reel 25 result in tension in release liner web 22. Shape memory in face stock 21A preferably prevents transponder 18 from remaining adhered to release liner 22 as it passes over peel device 23, resulting in the leading edge lifting off and separating from webbing 22. If take-up reel 24 continues to advance, and transponder 18 does not collide with another object, its attachment to release liner 22 on its trailing edge will result in that transponder being passed completely around peel device 23 onto take-up reel 24. Full path rotation is preferably reserved for transponders that fail to properly encode desired information; and is therefore intended to be a reject process for failed transponders. Preferred embodiments result in tension created in web 22 in a process of tensile extraction of transponders from a source reel and selective transfer of good transponders onto an object or a person's finger. Mobile encoder 30 depends on a person's finger to prevent transponders 18 from rotating around peel device 23. Mobile encoder 60 depends on a target object such as carton face 68 to prevent transponder 63B from rotating around peel plate 62B on a path toward take-up reel 61J.

When the conveyance of RFID transponders results in the positioning of a transponder relative to a near field coupler within a signal null, the transponder and transport webbing are preferably nudged forward or backward to improve the signal coupling. This is preferably accomplished by momentarily activating the motor and transponder transport means 15C.

C. Mobile Encoder

FIG. 1 shows a system 10 according to one embodiment of the present invention including a mobile encoder 15. FIG. 5 shows a preferred embodiment for a mobile encoder. Mobile encoder 30 is comprised of housing 32, belt clip 34, antenna 36, on/off switch 33, system ready LED 37, data ready LED 38, and transponder ready LED 39. It is further comprised of auxiliary switch 40, and charger plug 41. A cartridge or other pre-packaged self-contained supply of transponders 42 is preferably latched, snapped, clicked, popped, inserted, slid, or releasably mounted to the body of housing 32. The cartridge preferably includes a take-up reel 44 for non-dispensed RFID transponders, and a port through which blank or securely encodable transponders emerge from source reel 43. The source reel is preferably comprised of a core which may be made from plastic or a recyclable kraft paper fiber to form a wound tube. A tube extends from the walls of cartridge 42 to form an axle around which release liner and transponders are wound and subsequently unwound.

In certain preferred embodiments source reel or roll 43 is constructed using materials such as non-petroleum-based plastics, laminated paper layers, and materials primarily comprised of natural fibers. In another preferred embodiment the entire pre-packaged self-contained supply of unused transponders is transported to mobile encoder 15, loaded into it, consumed, and disposed of preferably without generating landfill waste.

A key aspect of this invention is a complete pre-packaged, pre-assembled, pre-threaded, self-contained supply of encodable transponders, preferably unlocked with cryptographic access methods. The supply is preferably configured for efficient transportation and shipping, conveyance to a work site, and easy loading into mobile encoder 15, preferably in a single fluid motion.

FIG. 6 is a preferred embodiment of system 10 wherein printed symbols are optically scanned by internal optical reader 66. The embodiment shown in FIG. 6 uses a preferred method of sensing the linear motion of mobile encoder 60 across a target surface by using an optical mouse sensor 65. Such devices are commonly used to track the hand movements of the operator of a computer. Motion in either the X or Y direction is translated into numerical displacement representations which when timed are converted into linear velocities. Tracking and processing the primary axis of motion parallel to the major axis of the release liner, the web speed is preferably controlled by processing means 15B and transponder transport means 15C such that transponder 63A advances at a rate of speed that matches the velocity of the entire mobile encoder across the target surface. Optical mouse 65 tracks displacement across the target surface and also acts as a tamp head to strengthen the adhesive bond of each freshly applied tag. The process of attachment of the encoded transponder to the target surface is along a vector that is nearly parallel to the target surface at a speed that is based on real time feedback from the surrounding environment as sensed by the optical mouse or other sensor. Optical mouse sensor 65 preferably illuminates its target surface with either a LED (Light Emitting Diode) or a laser. Avago Technologies of San Jose, Calif. manufactures a variety of mouse sensors, both LED-based and laser-based. Laser illumination provides smooth and accurate motion sensing across a variety of surfaces. The model ADNS-6150 small form factor lens working in conjunction with the ADNS-6530 integrated chip-onboard laser sensor and single-mode vertical-cavity surface emitting laser can be used to not only detect motion in the X and Y directions, but also to some degree in the Z direction. Displacement along the Z (depth) vector is reported by the decrease in the number of resolvable features within the field of view as the target surface fades away from the optical focal point. That measurement is reported in the surface quality (SQUAL) register.

Optical mouse sensor 64B is used to measure the linear velocity of transponders as they move along the path of the release liner toward peel device 62B, as well as sense the gaps and edges between transponders 63A and those adjacent to them. The physical outline 18 of transponders 63A are a reliable indication of the location of RFID inlay 21C located within each transponder 63A and enhance system performance with reliable positioning relative to near field coupler 64A2. The angular velocity of motor 67B and gear train 67A are controlled to achieve a linear transponder velocity that matches the velocity of the mobile encoder itself as it moves across the target surface. Therefore an operator with a fast hand motion is just as successful as a person with a slower hand motion, both will result in a transponder that lays flat, co-planar with the target surface, void of kinks or wrinkles that are characteristic of a poorly controlled transponder application process. In either case, transponder dispensing by transponder transport means 15C will not initiate until optical mouse sensor 65 preferably illuminates the target surface and detects a minimum number of valid features as reported by the SQUAL register internal to the ADNS-6530.

RFID Interrogator 64A encodes RF transponders using either LF (Low Frequency), HF (High Frequency), UHF (Ultra High Frequency), or microwave radio energy. Transponders may be powered by radio energy, light, or stored energy from a source such as a battery. RF coupling is preferably through a near field coupler, an inductive loop or other suitable transducer 64A2 connected to interrogator 64A to focus RF energy on a small area within mobile encoder 15, 30, or 60.

Certain preferred mobile encoder embodiments will not encode RF transponders that fail authenticity tests. In a like manner, RF transponders will preferably not allow themselves to be programmed unless the interrogator can successfully unlock its secured memory banks. This is a preferred method of protecting transponder cartridge and mobile encoder supply chains from counterfeits and knock-offs. Mobile encoder 15 and the transponders loaded into it will only be successful in exchanging certain data if certain data encryption and challenge response protocols are adhered to. In a preferred embodiment each authorized RFID transponder converter company uses one or more encryption keys to generate passwords that lock the RF tags, whereby preventing them from being programmed unless they are unlocked using the same password. Passwords of this type are specified in the EPC Gen 2 specification and in ISO standards. The passwords are preferably generated by processing means 15B using a public key from publicly readable data such as an asset number or a transponder serial number. A shared private key is then used by an encryption algorithm such as AES in order to create a password or a collection of passwords that can be used to lock or unlock one or several RF tags. Other methods may be used that provide a high degree of certainty that the both the transponders and the mobile encoders are from legitimate sources. Individual failures or patterns of authentication failures are preferably reported to a central database through wireless communications means 15A for subsequent fraud investigation.

Peel device 62B is part of the mobile encoder and preferably rotates or pivots about pivot point 62A into position 62C and a corresponding position (not shown) in FIG. 6. When cartridge 61 is inserted into applicator body 67F the web is held in a non-interfering position by guide post 61F and its accompanying cartridge guide post such that peel device 62C can self-thread around the transport web without human effort. This is an improvement over prior art where a peel device is an integral part of the pre-packaged self-contained supply of transponders and requires threading during the cartridge manufacturing process.

Peel device 62B preferably contains a shield on the outer face of the blade, through which radio energy will not pass to encode or interact with a rejected transponder 63B. The dielectric material of the peel device 62B provides sufficient separation from a transponder within the encoding zone and the shield on the back side of the peel device. This is another advantage over a peel device that is part of the cartridge, where the cost sensitivity is much more acute. The shielding on the back side of peel device 62B may be any suitable metal attached or adhered in any reliable or economical manner against the non-conductive dielectric structure of the peel device.

Rejecting transponder 63B requires that mobile encoder transponder peel device 62B have sufficient clearance from target surface 68 as determined by optical mouse sensor 65 using either the SQUAL reading or the shutter readings. Such readings are used to determine if there is sufficient space to advance and rotate a bad transponder 63B around the distal end of peel device 62B.

Several operator indicator lights 67E preferably include a system-ready LED, data-ready LED, tag-ready LED, and battery-ready LED on the housing with appropriately positioned light pipes to enable the operator an easy view of the mobile encoder device status.

Also included on the exterior of the housing are an external, power-cord receptacle so that the on-board lithium-ion, nickel metal hydride, or other appropriate battery 67D may be charged as required. An on/off switch enables the operator to selectively power up the encoder. A reset port, such as a recessed reset button enables an operator to reset the device circuitry on control board 67C as may be required.

A cartridge 61 containing a plurality of RFID transponders releasably mounts to the body of housing 67F. The cartridge further includes a take-up reel 61J for collecting release liner and non-dispensed RFID transponders, and a port through which blank or securely encodable transponders emerge from source reel 61E. The source reel is comprised of core 61A which may be made from plastic or a recyclable kraft paper fiber to form a wound tube. A tube extends from the walls of cartridge 61 to form axle 61B around which core 61A rotates. Brake shoes 61C create drag, resulting in back torque on the source core, the magnitude of which is controlled by screw 61D which with a knob (not shown) is used to adjust the force applied by brake shoes 61C. The back torque for cartridge 61 is alternatively developed through a motor or an expandable friction coupling into a brake mechanism attached to encoder body 67F.

Take-up core 61H is driven by a tight coupling with drive hub 61G. This tight coupling is achieved through a combination or selection of tight fit, expandable coupling, and sharp teeth. The result is a hub that will easily slide in or out of core 61H with little effort, but still be capable of delivering a substantial amount of drive torque through that connection without slippage.

Drive torque is delivered from gear motor 67B to hub 61G through drive gear 67A the teeth of which engage with each other as cartridge 61 is set into position and locked into place.

In a preferred embodiment, mobile encoder 30 cryptographically unlocks, encodes, and verifies each transponder one by one. In preferred embodiments, transponders are verified more than once. One time immediately after programming with a desired data payload, and then again a second time after encoder 60 automatically dispenses an RFID transponder 63A onto target surface 68. This second verification step insures that the properties of target surface 68 or other nearby materials do not adversely affect the performance of transponder 63A.

In another preferred embodiment, encoder 60 is used to encode and dispense a pattern of several transponders 63A onto a target surface 68 at regular intervals in order to map the surface of a container for example in order to determine an optimal location for a placement of transponders. This information is then preferably used for engineering and planning purposes for high-volume transponder application in a production or distribution facility. Transponders may be designed for operation in any or all of the UHF, HF, LF, or microwave frequency bands.

A plurality of cartridges 42 are preferably disassembled for easy recycling. For example, end users may choose to reduce their shipping costs for the recycling of cartridges and release liner by separating them into different recycle waste streams at the point of use. Conversely cartridges 42 are manufactured and assembled by snapping together the mating components with latches, guide pins, slots, and other such features to mechanically secure themselves into a rugged structure, capable of tolerating the abuse that is common for shipping and handling. After each use, cartridges 42 are preferably disassembled such that similar parts of like cartridges all nest within each other to form a dense stack. Each stack can then be accumulated and shipped either together or separately back to a transponder recycling facility. The spent release liner and any rejected transponders may also be accumulated separately and may optionally be sent to a different preferred waste processing facility, possibly in order to reduce shipping costs. One such facility preferably has the ability to reprocess release liner, both silicone and non-silicone-based materials. Certain silicone alternatives include emulsion release coatings that are water-based coatings that offer similar performance to hydrocarbon solvent-based release liner products. Emulsion coatings are compatible with paper repulping processes and are highly preferred. The benefits of the silicone alternative coatings are not normally available to the RFID tagging work flows because proper attention has not been given to solving this environmental problem. Therefore, by controlling both the composition of the outbound materials as well as the inbound recycling processes, this cartridge-based method of transponder encoding offers real promise for reducing stress on the environment.

In the aforementioned embodiments of the mobile encoder 15, 30, or 60, key features commonly shared include means to enable Gen2 EPC or ISO standards compliance. An on-board power source 57D, such as a rechargeable lithium-ion, Nickel Metal Hydride, or other battery enables freedom of movement. Mobility is further afforded by means for wireless connectivity to a data network, such as the 802.11 wireless LAN (Wi-Fi), Bluetooth, or other standards-based communications protocol. However, a conventional power source that requires connectivity to a power-grid and a cable-based data network connectivity link would work under certain circumstances.

Further, in contemplated embodiments, the fixed or mobile encoder enables selective mounting of a magazine or cartridge filled with un-commissioned RFID transponders, which facilitates rapid and easy loading of the encoder with ready-to-use RFID transponders and further enables re-use, re-commissioning, and recycling of un-dispensed transponders and the associated cartridge. The mobile encoder can be monitored and controlled by virtually any handheld or mobile device, a host computer in a central location, or over the Internet.

The mobile encoder 15 is activated (turned on) when an operator selectively depresses the combination on/off switch. Pushing the on/off switch, possibly in conjunction with a second switch for about three seconds or longer results in a sleep-mode cycle that can be interrupted by re-pressing the on/off-next switch. In sleep mode the operator indicators will turn off. If active, the mobile encoder system-ready LED illuminates and connects to the assigned network. Network connectivity may result in the illumination of both the system-ready LED and the data-ready LED.

Mobile encoders 15 and 30 optionally receive commands and data via the wireless link from the remote computer 12 or optical reader 13. Special bar code commands are scanned by optical reader 13, passed through wireless communication means 15A, and interpreted by processing means 15B mobile encoder 15 to perform certain pre-programmed functions. Commands originating from either computer 12, optical reader 13, or internal bar code scanner 66 (also designated in FIG. 1 as internal optical reader 15F) perform functions in categories that include power management, data management, wireless configuration, security, configuration options, and utilization of internal resources.

Data originating from computer 12, optical reader 13, or internal optical reader 15F typically represents information that is to be encoded on an RFID transponder. The information is processed by the encoder's on-board processor 15B and stored in memory 15G and the tag-ready LED of output indicator means 15K rapidly blinks green (cycles on/off to pulsate). An RFID transponder is moved from within cartridge 42 to a position near the distal edge of a peel device for encoding in the encoder and the transponder is encoded with the appropriate information. The transponder is tested, and if it contains the correct data and the encoding was successful then all three indicator LEDs indicate a solid-green color. The encoded RFID transponder is then ready to be attached onto the container of interest when the operator removes it and applies it to the target surface.

In the event that the encoding process failed, the bad transponder is detected and retained by the encoder, where it remains on the take up reel 44 inside cartridge 42. The take up reel also collects the release liner as the encoder 15 dispenses good transponders (properly encoded RFID transponders). The take up roll returns to a recycling center where components are reused or recycled as necessitated. Further, the recycling center can perform failure analysis on returned transponders.

Certain protective enclosures, such as cartridges or magazines 42, are part of a family of interchangeable magazines of similar size, shape, and functionality, which are capable of housing and dispensing certain types, styles, shapes, and sizes of new or used RFID transponders. Transponder sizes typically range from 4 mm-thick foam-backed transponders measuring 12 mm wide down to thin transponders that are 15 mm wide on 19 mm pitch.

In at least one embodiment, the magazine or cartridge includes a unique and embedded, RFID transponder which enables automatic interrogation and tracking of cartridge 42. In certain embodiments, to minimize interference, the cartridge-specific and unique RFID transponder or RFID transponder operates in a frequency band that is different than the supply RFID transponder contained within the protective enclosure. Alternatively, other embodiments selectively interrogate cartridge identification transponders that operate in the same band as transponders within the cartridge that are to be applied.

Certain encoders require replenishment of the battery or other internal, on-board power source, such as a fuel cell, or other energy storage technology. Accordingly, in some embodiments, an encoder 15 further includes a remote, selectively coupling base unit. The base unit enables a replenishment of magazines or cartridges, provides replaceable power sources, recharges the on-board power source, serves as a communications gateway, and provides a user interface for programming and maintenance of the encoder.

As with all ESD-sensitive equipment, care must be taken to avoid a build-up of damaging electrostatic charges. Accordingly, in certain embodiments charge is removed using a variety of conduction methods including wiping or use of special materials that contain short conductive elements optionally arranged within a flexible elastic cord.

In some embodiments, the encoder adapts to use a particular type of RFID transponder. One type of suitable RFID transponder is model number AD-220 or AD-222 from Avery Dennison of Brea, Calif., or Raflatac model 300846 from Tampere, Finland, or a Spider transponder or FT-33 FAT tag from RSI ID Technologies of Chula Vista, Calif. Such a transponder is die cut and adhered to release liner. Additionally, wireless sensors are manufactured to specifications that are compatible with the specific encoder, including such specifications as core diameter, outer diameter, and web width. Alternatively, certain steps are required to prepare a standard roll of transponders for use in an automated encoder, including unrolling from a large roll (up to about 6-inches in core diameter) onto several smaller rolls having a smaller core diameter (of about 1-inch to about 2-inches in core diameter).

For certain encoder embodiments passwords are encoded into transponders or wireless sensors when they are commissioned. Passwords are used to lock certain memory blocks. Passwords are safeguarded using cloaking, obfuscation, cryptographic techniques, secure and trusted channels, locked memory, and other methods that are commonly used to protect confidential information. Passwords are generated or retrieved from data encoded in an RFID transponder to generate an index into one or more databases that contain a one dimensional array of passwords, a two dimensional array of passwords, a multidimensional array of passwords, or an array of actual or pointers to algorithms used to generate passwords from transponder data, for example. Alternatively, cryptographic algorithms are used to generate passwords from transponder data.

Although this disclosure makes specific reference to a mobile encoder, it is understood that the encoder can easily adapt and be readily configured to a fixed operating environment. For example, it can be mounted to a forklift truck or a high-speed conveyer line and maintain advantages of autonomous encoding, rapid cartridge change-over and other qualities as discussed and developed more fully in this disclosure.

D. Method of Tagging Containers

FIG. 8 is a flow chart representing a method according to the present invention including applying RFID transponders to objects of interest. One suitable object of interest comprises transport containers such as corrugated cartons or shrink-wrapped cases on a shipping pallet, which is inadequately addressed by the prior-art, particularly for solutions for manually operated automatic encoding and attachment to a container.

Block 80 represents a process step including the identification and selection of a container to be tagged with an RFID transponder or wireless sensor. In one embodiment this step includes a manual selection and verification processes that consists of manual handling, visual sighting, and scanning bar codes with a manually operated optical reader device. This method contemplates that an operator is working from a pick list or customer purchase order or other such records to assure that goods are properly moved and accounted for. Preferred bar code scanners include those that allow an operator to freely handle cartons with two hands. Such scanners include laser bar code scanners or imagers that are worn on either that back of the operator's hand or near the top knuckle of a finger. Such scanners are described above, and preferably have a Bluetooth or similar wireless interface to connect to mobile encoder 15 or 30. Bar code scanner 66 of FIG. 6 is a preferred embodiment of an alternative device that combines manual bar code scanning and RFID transponder encoding into a single handheld device. The operator may choose to scan bar codes that contain data, application identifiers, commands, or other elements commonly found in automatic data capture applications.

Block 81 represents the process step of processing bar code information to derive the underlying data. Depending on the type of bar code, how it is encoded, and its purpose, different processing steps will be used. In preferred embodiments the bar code may contain SKU information, a GTIN, an SGTIN, EPC data structures, a military UID, an SSSC, an asset number, a file identifier, or other such identifying information. In certain preferred embodiments, the bar code (either one or two dimensional) contains a partial or complete description of the data that is to be encoded into the RF transponder. Such bar codes are described in ISO/IEC draft document PDTR 24729-1. Application identifiers 01 and 21 are combined with additional encoded printed information to fully specify a serialized GTIN (or SGTIN). Using such bar codes does not require the use of additional data in order to generate RF transponder payload data. Mobile encoder 15 may therefore independently receive and process the RF transponder payload information. One type of bar code is used to signal mobile encoder 15, 30, or 60 that it should enter a mode whereby it performs a serialization algorithm without using an AI 21 bar code.

Block 82 represents the process step whereby mobile encoder 15, 30, or 60 encodes an RFID transponder with the information of the previous step (Block 81).

Successful commissioning of the RFID transponder is preferably verified by the encoder as shown in Block 83. In one embodiment, the encoder tests the immediate transponder and determines if it is operating within certain predefined specifications including parameters such as activation energy, backscatter signal strength, sensor performance, and other indications of the quality of the transponder.

If in Block 84 the encoder determines that the transponder is not likely to result in a successful transponder deployment as may be determined by failure on multiple encoding and verification attempts or due to other evidence of physical or electronic deficiencies or abnormalities, then the operator is optionally informed and the failed or bad transponder is discarded automatically as shown in Block 85.

Block 86 is the process of using motor 67B and/or transponder transport means 15C to pull release liner 22 tighter and tighter such that webbing 22 advances forward to the point that the leading edge of transponder 18 extends past the distal end of peel device 23 or 62B.

In Block 87 web 22 is pulled forward to the point that transponder 18 or 63A begins to rotate around peel device 23 or 62B. It is in this step that either a human finger or some target object needs to be presented in the rotational path of the tipping transponder 18 or 63A must be located. In the case of mobile encoder 30 where the operator is required to handle the encoded tag, it is important that their finger be present as transponder 18 begins to tip, allowing adhesive layer 21D of transponder 18 to make contact and be removed for placement on a target object such as a shipping container, trackable asset, automobile windshield, or other object of interest. In cases where the operator scans a bar code and applies encoded transponder 18 in a single motion, mobile encoder 60 is preferred, wherein as transponder 18 tips as it rotates around peel device 62B adhesive layer 21D sticks directly onto target surface 68. In either case, encoded transponder 18 is caught mid-rotation and adhesive layer 21D provides adhesive forces sufficient to completely detach transponder 18 from release liner 22, thus completing the function of Block 87 where work flow returns to Block 80 for another transponder encoding cycle to begin.

While the invention has been particularly shown and described with reference to certain embodiments, it will be understood by those skilled in the art that various changes in form and detail may be made without departing from the spirit and scope of the invention.

I claim:

1. A mobile encoding system for commissioning RFID transponders, the system comprising:
an RFID interrogator adapted to enable encoding data using an internal antenna, the antenna being adapted to encode the data into an RFID transponder;
at least one memory storage device for storing an authorization to encode unique numbers into RFID transponders;
a bar code scanning means to acquire commands or data;
a processing means for controlling and communicating with the memory storage device, the bar code scanning means, the RFID interrogator and the internal antenna;
a means for constructing transponder data payloads by processing data gathered from bar code scanning means;
a means for presenting the RFID transponder within an operable range of the internal antenna or near field coupler to enable reading or encoding of the data payload;
a transponder separation device means; and
a means for providing a cartridge or a pre-packaged self-contained supply of RFID transponders conveyed on a web from which properly encoded transponders are removed.

2. The encoding system of claim 1 wherein the bar code scanning means further comprises: an imager or a laser, the imager or the laser adapted to be mechanically aligned with the internal antenna to read printed symbols which contain some or all of the transponder data payload.

3. The encoding system of claim 1 wherein the bar code scanning means further comprises a wireless communication means for communication with the processing means.

4. The encoding system of claim 1 wherein the means for presenting the RFID transponder comprises a motor assembly adapted to pull the RFID transponder from a supply reel.

5. The encoding system of claim 6 further comprising a pre-packaged self-contained supply of RFID transponders comprising the supply reel and a take-up reel.

6. The pre-packaged self-contained supply of RFID transponders of claim 5 further comprising a transponder separation device whereby the transponders are separated from a conveyance web.

7. The transponder separation device of claim 6 further comprising a means for radio frequency shielding and at least one sharp edge, whereby the sharp edge enables a release liner to separate from an adhesive-backed RFID transponder.

8. The encoding system of claim 1 further comprising a housing assembly for enclosing the internal antenna and a handle coupled to a surface of the housing.

9. The encoding system of claim 1 further comprising a housing assembly for enclosing the internal antenna and a mounting mechanism for selectively coupling the encoding system to a provided structure.

10. The encoding system of claim 1 further comprising a means for controlling linear transponder peel rate to a measured velocity, whereby the measured velocity is determined relative to a target object.

11. The encoding system of claim 1 further comprising a processing means for associating data read from an RFID transponder with new data, whereby the new data is programmed into the RFID transponder.

12. The encoding system of claim 1 further comprising:
a means for verifying that the RFID transponder was encoded;
means for dispensing an encoded RFID transponder; and
a means for not dispensing an improperly encoded RFID transponder.

13. The encoding system of claim 1 further comprising a plurality of memory storage devices for storing transponder authorizations wherein at least one of the memory storage devices couples to the processing means via the antenna and RFID interrogator whereby the one memory storage device is not physically coupled to the processing means.

14. A system for enabling on-demand, point-of-use commissioning of RFID transponders to uniquely identify an object, the system comprising:
an RFID transponder comprising a fixed spatial separation means along a conveyance web whereby the transponder adapts to wirelessly send and receive data packets corresponding to an information set;
an RFID transponder encoder device having a processing means and a memory means, the encoder device being adapted to sequentially convey one RFID transponder at a time into an interrogation field, the encoder device further including means for coupling radio frequency signals with one RFID transponder, means for reading and writing authorization of transponders, means for verifying the status of a commissioned transponder, and means for mechanically separating a transponder from the conveyance web;
a means for encoding authorization from an external authority for a selected numbering system;
a means for coupling a cartridge or other pre-packaged self-contained supply of the RFID transponders, the transponders being further adapted for tensile extraction from said supply; and
a bar code scanner adapted to resolve data ambiguities prior to transponder encoding.

15. The system of claim 14 further comprising a processing means to verify the functionality of a commissioned transponder after separation from the conveyance web.

16. The system of claim 14 further comprising a plurality of authorization transponders adapted to provide the RFID transponder encoder device sets of pre-authorized blocks of unique numbers for specific object classes.

17. A method for commissioning RFID transponders comprising:
providing an RFID transponder encoder having a transponder separation device;
providing information to the encoder;
providing a supply of RFID transponders;
acquiring object class information to encode multiple instances of unique numbers from that object class into an RFID transponder;
advancing the RFID transponder in the encoder;
reading information from the RFID transponder; and
encoding the object class instance information into the transponder.

18. The method of claim 17 further comprising:
providing a conveyance webbing coupled to the RFID transponder;
severing the conveyance webbing to remove each encoded transponder.

19. The method of claim 17 further comprising:
applying the RFID transponder to a target surface only if the information was properly encoded.

20. The method of claim 17 further comprising:
Providing transponder having a conveyance web or release liner; and
providing the encoder with a motor adapted to provide tension in the conveyance web or release liner in a direction along its major axis.
